(19) United States
(12) Patent Application Publication
(10) Pub. No.: US 2007/0275126 A1
(43) Pub. Date: Nov. 29, 2007

(54) Drip and Sip containment unit to catch melted confection.

(76) Inventor: Chi W. Chan, Bayside, NY (US)

Correspondence Address: Chi W. Chan, 201-02 26 Avenue, Bayside, NY, 11360, US

(21) Appl. No.: 11/749,630

(22) Filed: May 16, 2007

Related U.S. Application Data
(60) Provisional application No. 60/800,591, filed on May 16, 2006.

(51) Int. Cl. A23G 3/00

(52) U.S. Cl. 426/90

(57) ABSTRACT

Drip containment device to catch melted confection (For use of frozen confection on the stick or ice cream cone) The drip containment device provides protection for the users hands, clothes, furniture, floor, etc., from messy drips when consuming frozen confection without inconveniencing the user or interfering with the consumption of the frozen confection. In addition the melted confection caught by the present invention is safe to consume. Made from a single piece of flexible material.

### CROSS REFERENCE TO RELATED APPLICATIONS

This application claims the benefit of provisional application Ser. No. 60/800,591, filed May 16, 2006 by the present inventor.

### FEDERALLY SPONSORED RESEARCH

Not Applicable

### SEQUENCED LISTING OR PROGRAM

Not Applicable

### BACKGROUND OF THE INVENTION

1. Field of Invention

This present invention relates to a device that when placed under a frozen confection on the stick or ice cream cone will protect the users hands, clothing and surrounding floor area etc. from messy drips of the confection.

2. Prior Art

Adults and children alike enjoy frozen confections from ice cream cones to frozen confection on a stick. The problems with this yummy treat are that it's very messy to eat and handle. The messy drips from frozen confection gets on your clothes, your furniture, the floor, etc., and not to mention, your hand becomes very sticky and dirty from the drip. In addition if you are walking, talking, moving around or even just sitting still and watching TV you will increase your chances of making a mess on your clothes, your furniture, etc., because you will not be able to concentrate on your frozen confections as it melts. The most common solution to this problem is to wrap the packaging the frozen desert comes in, or a napkin around the frozen confection. Unfortunately, it does not provide adequate protection for hands, clothing, floor areas, furniture or etc. and still leaves a messy napkin and a sticky hand.

There has been prior art that tried to solve these messy problems, U.S. Pat. No. 6,182,854. Jimenez (2001); U.S. Pat. No. 5,515,998. Wang (1996); U.S. Pat. No. 5,224,646 Biancosino (1993). The problems with these devices are they are too cumbersome and difficult to use and too big and bulky to be carried around by the user. In addition it is troublesome and time consuming to clean up these prior art after each use. Another draw back to these prior art is that they are expensive to manufacture. There are inexpensive prior art that tried to solve the same problem like U.S. Pat. No. 5,152,454 U.S. Warta (1992) Pat. Even though it might be inexpensive to manufacture, it is not any easier to use. It is difficult to assemble, you would need to spend a great deal of time studying the instructions and still have difficultly putting it together. In addition, the wrapper that's protecting the ice cream cone gets in the way of eating the ice cream cone, because once the user is done eating the ice cream above the cone and it's protective wrapper, the user has to tear away the wrapper to get to the rest of the ice cream cone thereby inconveniencing the user.

### OBJECTS AND ADVANTAGES

Accordingly, objects and advantages of my invention are to provide an improved drip containment device to catch melted confection when is being consume, the following are:
1. to provide a drip containment device that prevents unsanitary sticky mess when consuming frozen confection;
2. to provide a drip containment device that is convenient to use;
3. to provide a drip containment device that is ergonomically designed for easy handling;
4. to provide a drip containment device that can be made into a disposable or reusable item;
5. to provide a drip containment device that will catch melted confection as it melts, breaks off or, like those frozen desserts with crispy coatings like chocolate or nuts, tend to flake off and allow it to be safe and sanitary to consume;
6. to provide One-piece construction that is easy and fast to assemble.
7. to provide a drip containment device that is small in size and can be easily carried anywhere;
8. to provide a drip containment device that is effortless to clean;
9. to provide a drip containment device that can be perfect for promotional uses.
10. to provide a drip containment device that can be easily handled by children and messy adults;
11. to provide a drip containment device that can be a fun collectable item;
12. to provide a drip containment device that is inexpensive to manufacture and ship.

Further objects and advantages will become apparent from study of the following description and the accompanying drawings.

### SUMMARY OF THE INVENTION

In accordance with the present invention a drip containment unit to catch melted confection provides protection, for the users hands, clothes, furniture, floor, etc., from messy drips when consuming frozen confection (frozen confection on the stick or ice cream cone) without inconveniencing the user or interfering with the consumption of the frozen confection. In addition the melted confection caught by the present invention is safe to consume.

### BRIEF DESCRIPTION OF THE DRAWING FIGURES

I have provided 11 figure drawings.

FIG. 1 is a flat pattern for a construction of one embodiment (ice cream cone) of the invention prior to folding and formation thereof into the Drip and Sip containment unit of the present invention.

FIG. 2 is a bottom view of one embodiment (ice cream cone) of the present invention.

FIG. 3 is a perspective top view of one embodiment (ice cream cone) of the present invention.

FIG. 4 is a perspective view of one embodiment (ice cream cone) of the present invention in application with the ice cream cone inserted in the center of the invention

FIG. 5 is a flat pattern for a construction of one embodiment (frozen confection on the stick) of the invention prior to folding and formation thereof into the Drip and Sip containment unit of the present invention.

FIG. 6 is a view of the invention in the process of folding and formation thereof into the Drip and Sip containment unit of the present invention (frozen confection on the stick).

FIG. 7 is a bottom view of one embodiment (frozen confection on the stick) of the present invention.

FIG. 8 is an angle top view of one embodiment (frozen confection on the stick) of the present invention.

FIG. 9 is a perspective view of one embodiment (frozen confection on the stick) of the present invention.

FIG. 10 is a perspective view of one embodiment (frozen confection on the stick) of the present invention with a frozen confection on the stick inserted in the center of the invention.

FIG. 11 is a perspective side view of one embodiment (frozen confection on the stick) of the present invention with a frozen confection on the stick inserted in the center of the invention.

### DRAWING REFERENCE NUMERALS

2—The structure or the shaped of the invention

4—The surface of the structure

6—Opening space for inserting ice cream cone

8—The outer edge of the opening

10—The slits surrounding the opening

12—The slit in the middle of the structure also know as Line A (a visual marking)

14—Visual marking also know as Line B

16—The surface area of a tab located on the left side of Line A; also know as Tab C

18—The surface area of a tab located on the left side of Line A

20—It is the slit located on the left side of Line A

22—It is the slit located on the right side of Line A

24—It is the interlocking curve located on the bottom end of slit 20

26—It is the interlocking curve located on the bottom end of slit 22

28—The space between slit 22 and Line B

30—Ice cream cone

32—Ice cream

62—The structure or the shaped of the invention

64—The surface of the structure

66—Opening space for inserting frozen confection on the stick

68—The outer edge of the opening

70—The slits surrounded the opening

72—The slits at the opposite end of the structure, also know as Line A (a visual marking)

74—Visual marking also know as Line B

76—The slit located on the left side of Line A

78—The slit located on the right side of Line A

77—It is the interlocking curve located on the bottom end of slit 76

79—It is the interlocking curve located on the bottom end of slit 78

80—The surface area of a tab located on the left side of Line A; also know as Tab C

82—The surface area of a tab located on the left side of Line A

84—The space between slit 78 and Line B

86—Stick

88—Frozen confection

### Detailed Description Preferred Embodiments

The present invention provides a simple and versatile frozen confection drip containment device to catch melted confection made from a single sheet of material. The drip containment device is specially designed so that it may be folded upon itself to form two separate designs, one to be use for frozen confection on the stick creating a shallow convex dish, and the other to be use for frozen confection in a cone creating conical sleeve. Both of these devices are designed to surround the wide upper opening of an ice cream cone or to fit around the stick of frozen confection on the stick in order to prevents messy drips when consuming frozen confection on to users hands, clothes, furniture, floor, etc.

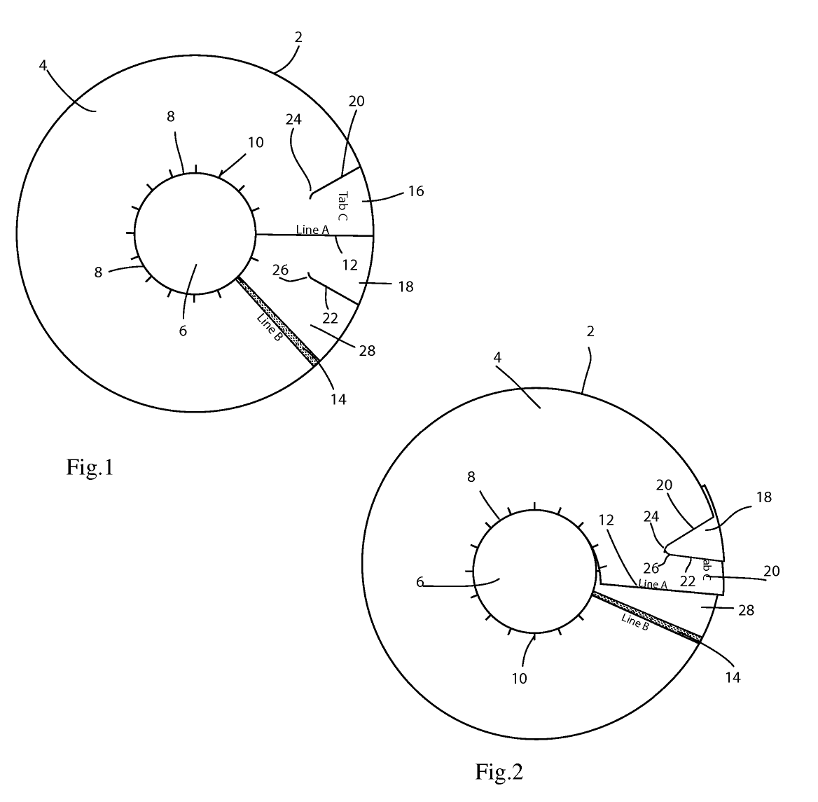

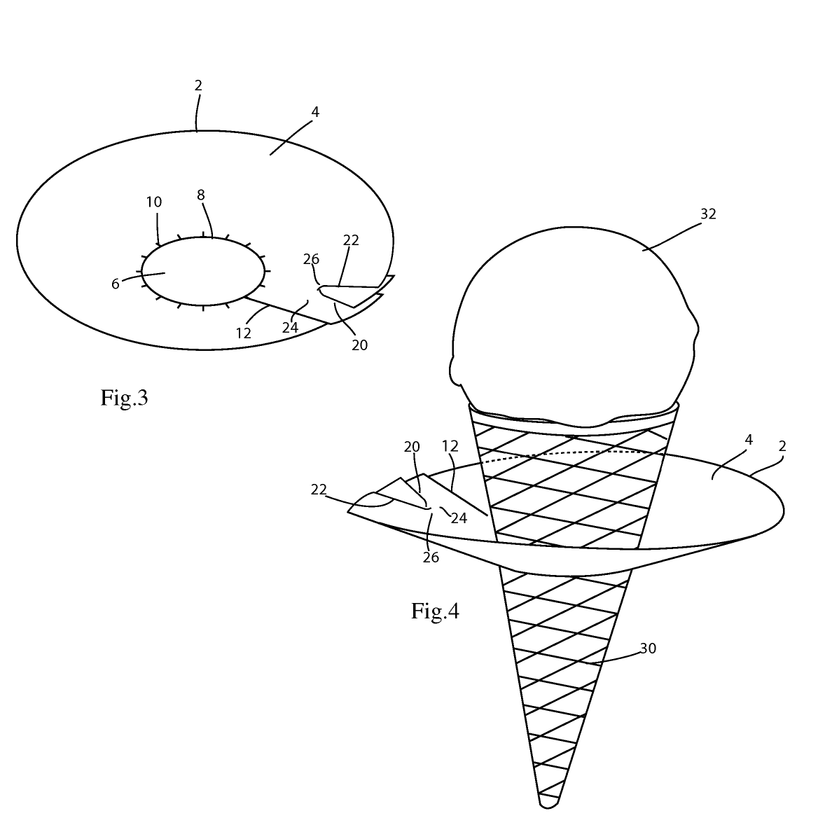

The first embodiment in making the present invention (ice cream cone) drip containment unit, referring to the drawing in FIGS. 1-4 the invention (ice cream cone) comprises a die cut pattern on to a sheet of flexible material like; paper, cardboard, wax coated paper, plastic, or other suitable flexible material. While dimensions, pattern and shape may vary, the pattern for the present invention (ice cream cone) consists of a basic donut shaped [2] with a center opening [6] to be able to insert the ice cream cone, the edge [8] of the opening [6] is surrounded by slits [10] to allow a better and tighter fit for ice cream cones of different sizes. Another embodiment of the present invention is the slit in the middle of the structure [12] on the pattern, also known as Line A (a visual marking). On opposite side of Line A [12] there are two (V-shaped like) angle slits [20] [22] which gives the invention (ice cream cone) its convex conical shape that is necessary to contain the messy drips from the melted confection. For added support to the structure of the invention, there are interlocking curves [24] [26] at the bottom of slits [20] and [22]. The visual marking Line B [14] is not part of the die cut pattern of the invention. Line A and line B are visual aids to help user to assemble the present invention.

Directions for putting the present invention (ice cream cone) together: simply slide the Line A [12] over (the surface of area [18] [28]) to match up with Line B [14].

Then push in Tab C [16] and slide Line A [12] away from Line B [14] simultaneously you are sliding slit [20] and slit [22] together, thereby hooking the two slits together. This in turn will interlock the two bottom curves [24] [26] together as well as slit [20] and [22] for a more secure and snug fit around the ice cream cone. Then, insert ice cream cone [30] [32] into the center opening [6] of the structure [2].

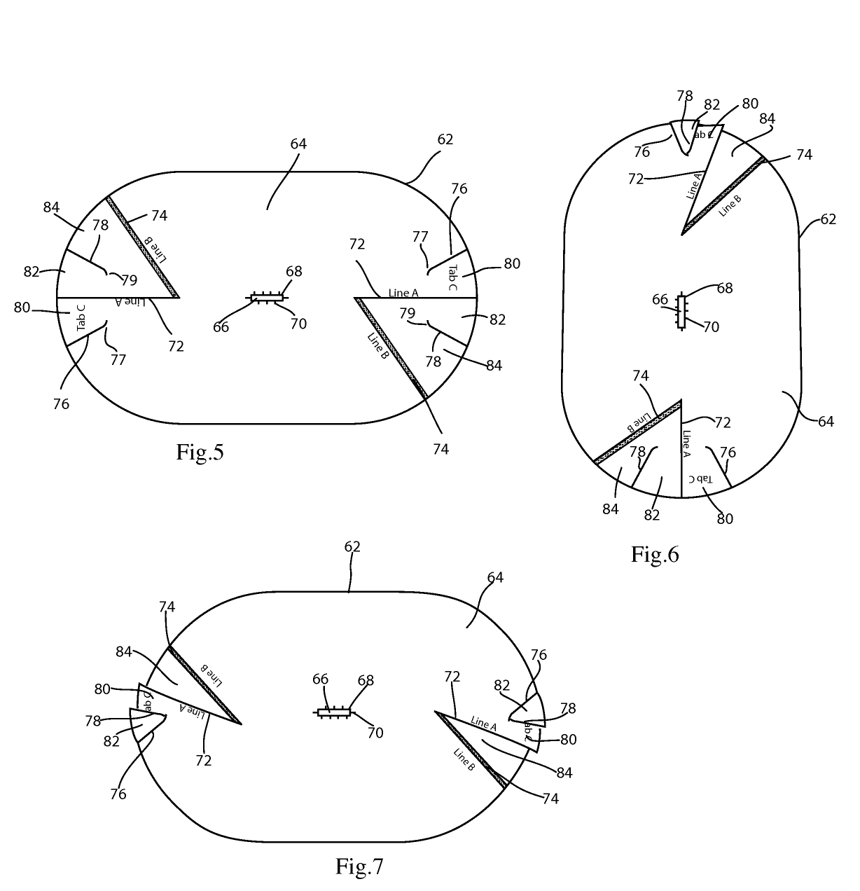

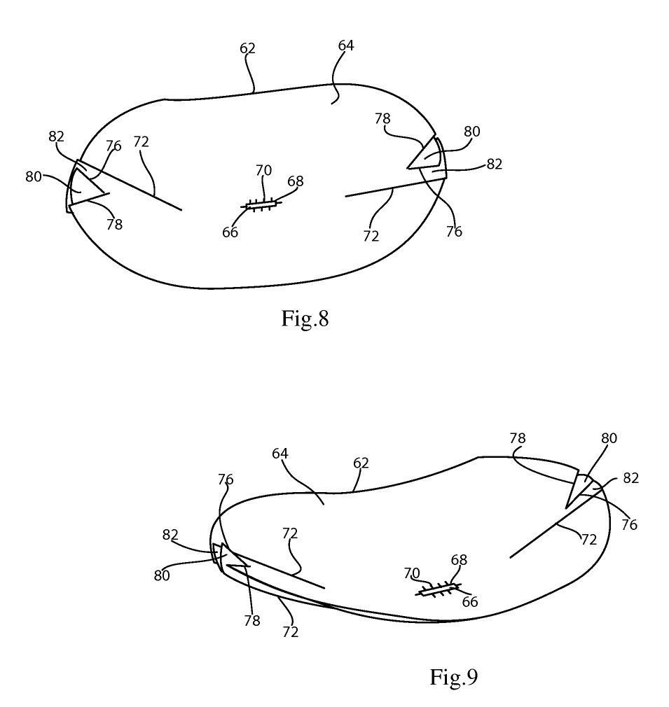

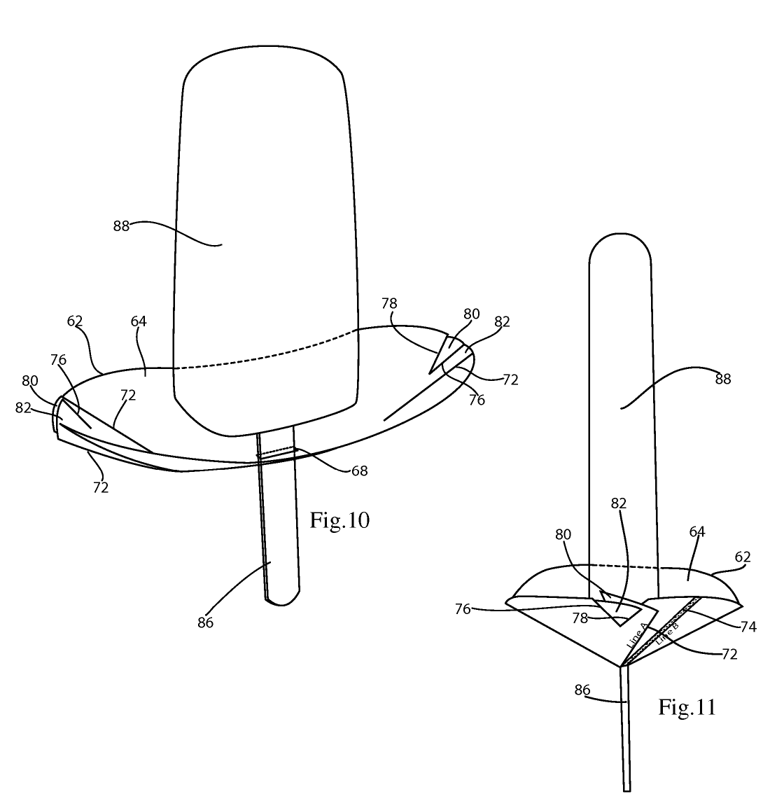

The embodiments making the present invention (frozen confection on the stick) drip containment unit, are referred to in the drawings in FIGS. 5-11 The invention (frozen confection on the stick) comprises a die cut pattern on a sheet of flexible material like; paper, cardboard, wax coated paper, plastic, or other suitable flexible material. While the dimension, pattern and shape may vary; the die cut pattern for the present invention (frozen confection on the stick) consists of an oblong shaped [62] with a centered small rectangle opening [66] in the structure [62] to be able to insert the stick of the frozen confection, the edge [68] of the opening [66] is surrounded by slits [70] to allow a tighter and more secure fit for the stick of the frozen confection. Another embodiment of the present invention shows the slits [72] located at opposite ends of the structure [62] on the pattern, also known as Line A (a visual marking). On both sides of Line A [72] there are two (V-shaped) angle slits [76] [78] which give the invention (frozen confection on the stick) its convex dish shape that is necessary to contain the messy drips from melted confection. The visual markings Line B [74] are not part of the die cut pattern of the invention. They are only visual aids to help the user to assemble the present invention.

Directions for putting the present invention together: start at one end of the oblong shape [62] simply slide the Line A [72] over (the surface area of [82] [84]) to match up with Line B [74]. Then push in tab C [80] and slide Line A [72] away from Line B [74], simultaneously you are also sliding slit [76] and slit [78] together, hooking the two slits together. This in turn will interlock the two bottom curves [77] [79] together as well as slit [76] and [78] for a more secure lock. Now rotate the structure [62] at 180 degrees and Repeat the same sequence as mentioned above. After both sides of the structure [62] have been assembled, insert frozen confection on the stick [86] [88] into the center opening [66] of the structure [62].

I claim:

1. A drip containment device for catching melted confection from frozen confection on the stick or ice cream cone; made from a single sheet of flexible material like paper, cardboard, wax coated paper or other suitable flexible material; with an option of being made into disposable or reusable drip containment device.

2. A drip containment device; having a shallow convex dish for frozen confection on the stick and a conical sleeve for ice cream cone; for catching melted confection to provide protection for the users hands, clothes, furniture, floor, etc., from messy drips when consuming frozen confection without inconveniencing the user or interfering with the consumption of the frozen confection.
